(19) United States
(12) Patent Application Publication
(10) Pub. No.: US 2007/0095746 A1
(43) Pub. Date: May 3, 2007

(54) Filter element seal structure and mounting method

(76) Inventors: Eugene Minichello, Fort Worth, TX (US); James G. McQuaid, Mineral Wells, TX (US)

Correspondence Address: Charles D. Gunter, JR.;Whitaker, Chalk, Swindle & Sawyer, L.L.P., Suite 3500, 301 Commerce Street, Fort Worth, TX, 76102-4186, US

(21) Appl. No.: 11/263,512

(22) Filed: Oct. 31, 2005

(51) Int. Cl. B01D 27/00

(52) U.S. Cl. 210/450; 210/323.2; 210/446; 55/490; 55/342

(57) ABSTRACT

The present invention relates to an apparatus for filtering a gas or liquid stream such as a natural gas stream. The apparatus includes a closed vessel having a longitudinally extending length, an initially open interior, an inlet port at one extent and an outlet port at an opposite extent thereof. A partition located within the vessel interior divides the vessel interior into a first chamber and a second chamber. At least one opening is provided in the partition. A filter element is disposed within the vessel to extend from within the first chamber. A special seal structure formed of a resilient material and having conically shaped sidewalls is used to seal against one end of the filter element as well as forming a dynamic seal with the vessel riser in use.

### BACKGROUND ART

1. Field of the Invention

The invention relates to filter vessels used to filter gas and liquid streams and to filter elements for such vessels, and, more specifically, to an improved seal structure and method for mounting the filter elements within the interior of the associated filter vessel.

2. Description of Related Art

Gas filter elements for filtering dry gas streams as well as for separating solids and liquids from contaminated gas streams are well known, as are gas filter elements for coalescing entrained liquids from a gas stream. These general types of gas filter elements may be installed in single stage or multi-stage vessels, which are in turn installed in a gas pipeline, to perform the required filtering functions. For example, Perry Equipment Corporation of Mineral Wells, Tex., offers the “Series 85, 88 and 90” Gas Filter and Filter/Separator Units.” The “Series 85 Filter/Separator” is a two stage unit. The first stage employs PEACHY filter-coalescing filter elements, also commercially available from Perry Equipment Company. These elements remove the solids contamination and coalesce any entrained liquid droplets. The coalesced liquid is then removed in the second stage high efficiency vane mist eliminator and collected in the liquid sump to be drained. The “Series 90 Filter/Separator” is designed for filtering dry gas or air streams. These units are useful in removing desiccant fines, pipe scale and other solid contaminants on the order of one micron and larger. They employ single stage filtration and are capable of utilizing a number of different filter element styles.

In the area of liquid filtration, the PECO® “Series 57” and “PEACH® TRITON LIQUIPUR® Series 58” liquid filtration units meet industrial ASME code for filtering liquid flows ranging from about 1 GPM to 3900 GPM or upwards. They are designed to use a multitude of string/pleated and PEACH® type filter elements for almost any liquid filtering application.

In the patent literature, U.S. Pat. No. 5,919,284, issued Jul. 6, 1999, and U.S. Pat. No. 6,168,647, issued Jan. 2, 2001, both to Perry, Jr., and assigned to the assignee of the present invention, disclose multi-stage vessels using individual separator/coalescer filter elements to separate solids, filter liquids, and coalesce liquids. The foregoing multi-stage vessels, as well as a multitude of other similar filtration vessels used in industry utilize solid or hollow core tubular elements, typically formed at least partially a porous filtration media. For example, the PEACHY porous filtration elements useful in the above type of filtration vessels are of the same general type as those that are described in U.S. Pat. No. 5,827,430, issued Oct. 27, 1998 to Perry, Jr., et al., and assigned to the assignee of the present invention.

Despite advances made in filter/separator vessel technology, a need continues to exist for an improved filter element seal structure and mounting method for mounting filter elements in vessels of the above discussed type.

A need exists for an improved seal structure for filter elements of the above type which is simple in design and relatively economical to manufacture and yet which presents a reliable and effective sealing action in a variety of different sealing applications.

### BRIEF SUMMARY OF THE INVENTION

An improved seal structure is shown for a tubular filter element used to filter a fluid stream in an industrial process where the fluid stream passes through a filter vessel having rigid risers for mounting the filter elements. Each of the filter elements comprises a tubular body with generally cylindrical sidewalls formed of a porous material, an interior, a first end opening and an oppositely arranged second end opening. The improved seal structure of the invention is comprised of a resilient body having conically shaped sidewalls which are tapered with respect to a central axis of the resilient body and which extend between a first lip region and a second lip region of the body. A selected one of the first and second lip regions of the resilient body is adapted to seal on a selected end opening of the filter element. The conically shaped sidewalls of the filter element form a dynamic seal with the riser element of the filter vessel on which the filter element is mounted and with the filter element body when subjected to a pressure differential between an upstream portion of the process and a downstream portion of the process being filtered.

A selected one of the first and second lip regions of the body of the seal structure terminates in a flared collar region also formed of a resilient material and with opposing exposed sides. One of the opposing exposed sides of the collar region seals against an end opening of the filter element and the other opposing side seals against the vessel riser. In one version of the seal structure, the collar region is a planar member of generally uniform thickness. The vessel riser may terminate in a flat planar surface or may have a circumferential thimble region which forms a relatively narrow edge at an outer extent thereof, the selected opposing exposed side of the flared collar region of the seal structure forming a compression seal with the edge of the circumferential thimble region of the riser as the edge bites into the collar region of the seal structure in use. The seal formed between the thimble region of the riser and the flared collar region of the seal structure is in the nature of a flat gasket compressive seal, while the seal formed between the conically shaped sidewalls of the seal structure and the riser interior is an annular seal along the length of the conically shaped sidewalls which is energized by the differential pressure created between existing upstream and downstream process conditions.

In another version of the seal structure, the collar region forms a circumferential recess on one side thereof to engage one end of the filter element sidewalls. The conically shaped tapered sidewalls of the seal structure form a relatively larger outer diameter flared bottom for the seal structure which extends upwardly toward a relatively narrower top region of the seal structure. The seal structure is received within the interior of the generally tubular body of the filter element with the flared bottom forming a seal with a selected end of the filter element. The vessel riser extends upwardly within the interior of the filter element interior and within an interior region of the seal structure where it contacts and seals against the seal structure in use. The seal structure extends for a predetermined length between the opposing outer lips thereof, whereby the length of the seal structure occupies a given distance within the interior of the filter element and as a result liquid flow through the element from the inside to the outside thereof is directed higher up the interior of the filter element than would occur without the sealing element being present within the interior of the filter element.

A filter element and improved seal structure are also shown for an apparatus that is used for filtering a gas or liquid stream such as a natural gas stream or a natural gas processing liquid stream. The apparatus includes a closed vessel having a length and an initially open interior. A partition is disposed within the vessel interior. The partition has a planar inner and planar outer side, respectively, dividing the vessel interior into a first chamber and a second chamber. At least one opening is provided in the partition over which is provided a rigid riser for mounting a filter element. An inlet port is provided in fluid communication with the first chamber. An outlet port also provides fluid communication from the second chamber. At least one tubular filter element is disposed within the vessel and mounted upon the rigid riser. The filter element comprises a tubular body with generally cylindrical sidewalls formed of a porous material, an interior, a first end opening and an oppositely arranged second end opening as previously described. The above described seal structure with its resilient body and conically shaped sidewalls are used to form a secure seal with the vessel riser. The conically shaped sidewalls of the filter element form a dynamic seal with the riser element of the filter vessel on which the filter element is mounted and with the filter element body when subjected to a pressure differential between an upstream portion of the process and a downstream portion of the process being filtered.

The above as well as additional objects, features, and advantages of the invention will become apparent in the following detailed description.

### BRIEF DESCRIPTION OF THE DRAWINGS

FIG. 1 is a side elevational view, partly broken away, of a gas filter vessel having several filter elements with the seal structure of the invention installed therein.

FIG. 2 is a side elevational view, similar to FIG. 1, but of a liquid filter vessel having several filter elements with the seal structure of the invention installed therein.

FIG. 3 is an exploded view of the improved seal structure of the invention showing the assembly thereof onto a porous filter element.

FIG. 4 is an assembled view of the seal structure and filter element of FIG. 3 with portions of the filter element broken away showing the interior thereof, the seal structure and the riser.

FIG. 5 is a view similar to FIG. 3 of another version of the seal structure of the invention for use in a liquid filtration installation.

FIG. 6 is an assembly view of the seal structure and filter element of FIG. 5 in place on the riser of a liquid filtration vessel.

FIGS. 7 and 7A are simplified, schematic views showing the seal structure and filter element of FIG. 5 in place on the riser of a liquid filtration vessel with the filter element being subjected to a differential pressure loading.

FIG. 8 is a schematic view, similar to FIG. 7, but showing the seal structure of the invention in place on a gas filter element and showing the element installed on the riser of a gas filtration vessel.

### DETAILED DESCRIPTION OF THE PREFERRED EMBODIMENT

Turning to FIG. 1 there as shown a filter vessel of the invention designated generally as 13 of the type which is used to filter a fluid stream in an industrial process. By the term “fluid” in this discussion is meant either “liquid” and/or “gas.” The particular filter vessel 13 which is shown in FIG. 1 is a dry-gas filter. Filter vessels of the general type illustrated might be utilized, for example, in oil and gas separation processes and similar industrial environments. While FIG. 1 illustrates one embodiment of a natural gas filtration vessel, it will be understood by those skilled in the art that the filter elements and seal structures covered by the present invention can be applied to a variety of such vessels used in the industry. For example, the filter elements of the invention might be employed in vessels which are used for simultaneously filtering solids, separating liquids, pre-coalescing liquids, and coalescing liquids out of a gas stream. The filter elements might also be utilized in vessels used for coalescing and separating two liquids and for filtering solids out of liquids. Also, while the vessel shown in FIG. 1 illustrates three principally visible filter elements mounted within the vessel above the vessel partition, it will be understood that some vessel designs will employ a variable number of elements, i.e., either more or less elements, depending upon the end application for the filter vessel.

Referring again to FIG. 1, it should be understood that although the vessel 13 is shown in a generally vertical configuration, that other vessels of the same general type may also be configured in a generally horizontal embodiment. The vessel 13 has a generally tubular shell 15 which forms a closed vessel having a length and an initially open interior 17. The shell 15 is enclosed at an outlet end 19 by means of a closure member 21 which, in this case, is a fluid tight flange. The shell 15 is permanently enclosed at an inlet end 23 by a welded base 25. The flanged closure 21 provides a fluid tight seal with respect to the inlet end 19 as well as access to the filter elements. In the embodiment of FIG. 1, three filter elements 27 are supported within the vessel open interior 17 by means of a vessel partition 29 and support elements or “risers” 31. The vessel 13 is preferably manufactured of steel materials which conform to published pressure-vessel standards, such as ASME Boiler and Pressure Vessel Code, Section VIII, Division 1.

The partition 29 which divides the vessel interior into the first and second filtration chambers has a planar inner and planar outer opposing sides 33,35, respectfully. An opening is provided in the partition 29 for each filter element to be mounted thereon. A vertically extending riser 31 is mounted over each partition opening, as by welding, for receiving an end of a filter element. An inlet port 37 is in fluid communication with the first chamber and an outlet port 39 is in communication with the second chamber. The tubular filter elements 27 are disposed within the vessel to sealingly extend within the second chamber and to communicate through the associated riser and its associated opening in the partition 29 into the first chamber of the vessel. Gas flow is through the inlet port 37, through the first chamber, through the riser interiors, into a hollow interior of the filter elements 27 and out the sidewalls thereof, and through the second chamber to the outlet 39. The direction of the gas flow is indicated by the arrows in FIG. 1.

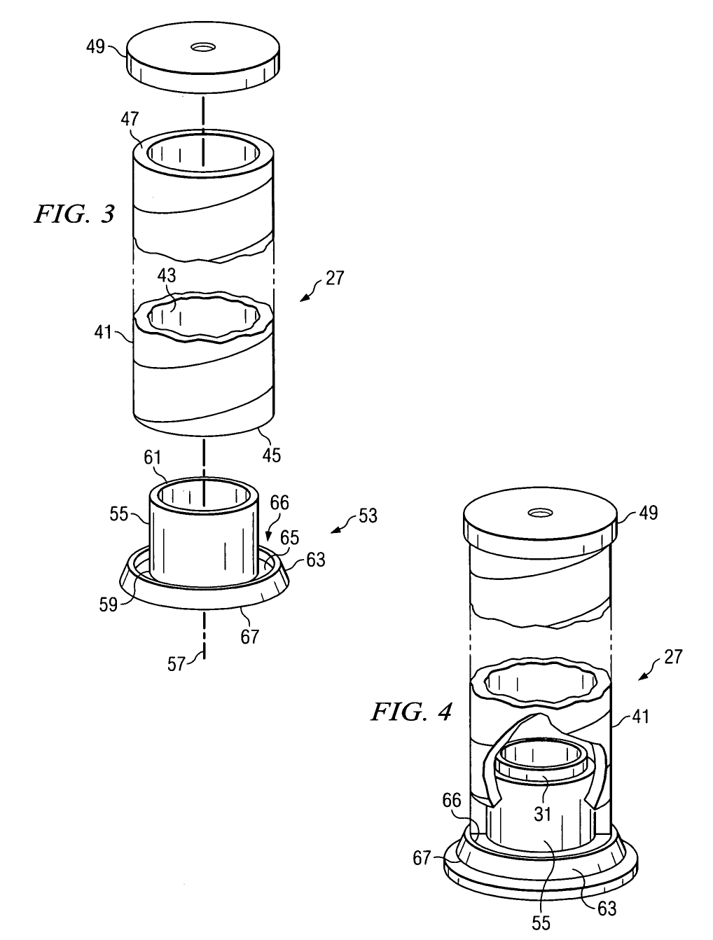

Each of the filter elements 27 (FIG. 3) comprises a tubular body with generally cylindrical sidewalls 41 formed of a porous material. The filter elements have an interior 43, a first end opening 45, and an oppositely arranged second end opening 47. The end opening 47 is surrounded by an end cap 49, respectively, which may be formed, for example, of metal or rigid plastic.

The bodies, or tubular filter walls of the filter elements of the invention can be formed of any material conventionally used in the art. The construction of the filter elements will vary depending upon the particular end application of the filtration vessel. By way of example, the filter elements can be constructed in the manner and of the materials disclosed in U.S. Pat. No. 5,827,430, issued Oct. 27, 1998 to Perry, Jr., et al. Such filter elements are sold commercially under the PEACH® trademark by Perry Equipment Corporation of Mineral Wells, Tex. In a typical application, the filter elements consist of four multi-overlapped layers of non-woven fabric strips of varying composition. The first layer is composed of equal amounts by volume of fibers purchased commercially from Hoechst Celanese under the fiber designations “252,” “271,” and “224,” and has a basis weight of 0.576 ounces per square foot, is ten inches wide, and is overlapped upon itself five times. The denier of fiber “252” is 3 and its length is 1.500 inches. The denier of fiber “271” is 15 and its length is 3.000 inches. The denier of fiber “224” is 6 and its length is 2.000 inches.

The second layer is composed of equal amounts by volume of “252,” “271,” and “224,” has a basis weight of 0.576 ounces per square foot, is eight inches wide, and is overlapped upon itself four times. The third layer is composed of equal amounts by volume of “252,” “271,” and “224,” has a basis weight of 0.576 ounces per square foot, is eight inches wide, and is overlapped upon itself four times. The fourth layer is composed of equal amounts by volume of “252” and a fiber sold under the name “Tairilin,” has a basis weight of 0.576 ounces per square foot, is six inches wide, and is overlapped upon itself three times. Fiber “252” being of the core and shell type serves as the binder fiber in each of the aforementioned blends.

The above example of particular types of material, fabric denier, number of wrapping layers, etc., is intended to be illustrative only of one type of filter material useful in the practice of the present invention. The seal structure of the elements of the invention could be used with a variety of other conventional filter materials, as well.

A seal structure (53 in FIG. 3) is used to mount the filter element 27 on the riser element 31 (see FIG. 4). As can be seen in FIG. 3 and FIG. 4, the seal structure 53 comprises a resilient body having conically shaped sidewalls 55 which are tapered with respect to a central axis 57 of the resilient body and which extend between a first lip region 59 and a second lip region 61 of the body. By “resilient body” is meant that the seal structure 53 is comprised of a suitable elastomer, such as a commercially available synthetic or natural rubber, urethane, etc. The resilient body 53 can conveniently be, for example, injection molded rubber or plastic.

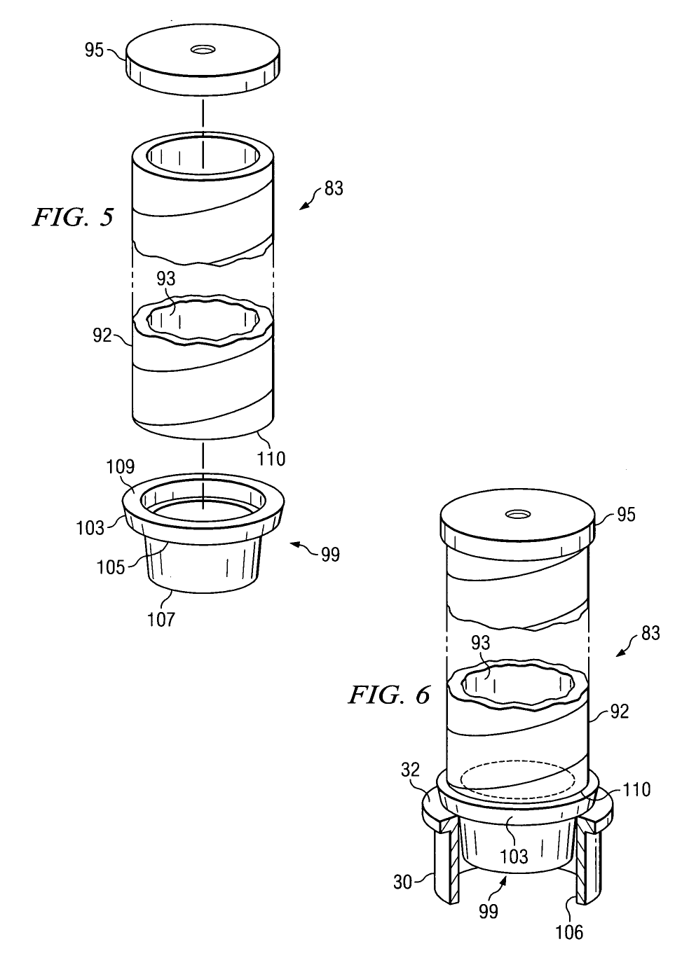

At least a selected one of the first and second lip regions 59, 61 of the resilient body 53 is adapted to seal on a selected end opening 45, 47 of the filter element 27. In the embodiment of the seal structure 53 shown in FIG. 3, the first lip region 59 of the body terminates in a flared collar region 63 which is also formed of a resilient material. The collar region 63 has opposing exposed sides 65, 67. As shown in FIG. 5, one of the opposing sides 65 of the collar region 63 forms a circumferential recess 66 about the cylindrica sidewalls 55 and receives and engages one end of the filter element 27. The seal structure thus actually replaces one end cap of the filter element and can be taken on or off by merely sliding the filter end out of the circumferential recess 66. As will be explained in greater detail, the opposing side 65 of the seal structure 53 forms a compression seal with the filter element 27 due to the forces exerted thereon during the operation of the vessel.

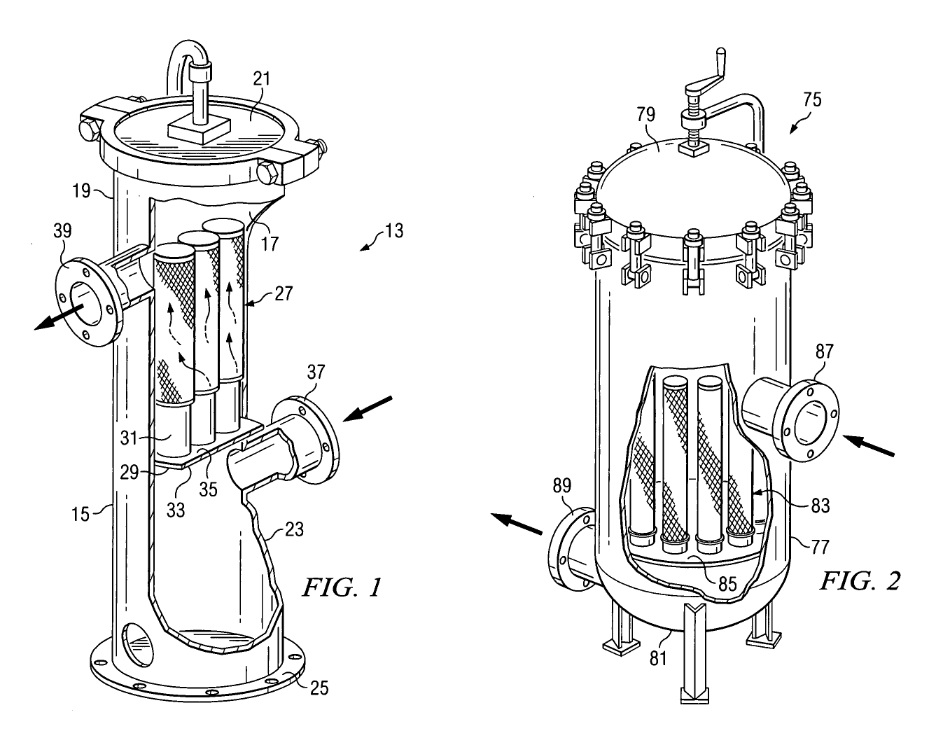

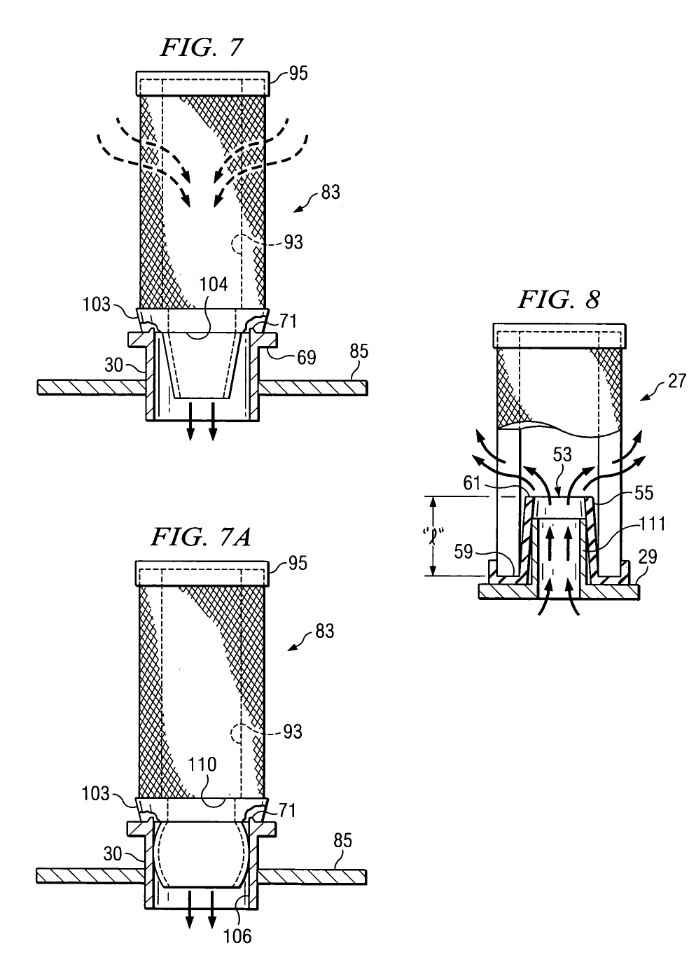

Turning briefly now to FIG. 2 of the drawings, there is shown a typical liquid filter vessel 75 of the invention. The liquid vessel 75 is again a tubular shell 77 having a flanged cover 79 and closed bottom 81. A plurality of filter elements 83 are mounted on a partition 85 which separates the vessel interior into a first and second chambers. An inlet opening 87 communicates with the first chamber while an outlet 89 communicates with the second chamber. The liquid vessel 75 illustrated in FIG. 2 is similar structurally in most respects to the gas filter vessel illustrated in FIG. 1 except that it operates in a “reverse flow” manner where the material to be filtered or coalesced moves from the outside of the filter elements 83 toward the inside of the elements. This type reverse flow is illustrated schematically by the arrows in FIG. 7 of the drawings.

FIGS. 5 and 6 illustrate a filter element 83 formed of a porous material, having external sidewalls 92, an interior 93, and an end cap 95. In this embodiment of the invention, the seal structure 99 is again a resilient body having conically shaped tapered sidewalls which form a relatively large outer diameter flared top region for the seal structure which extends downwardly toward a relatively narrower bottom region of the seal structure. The seal structure 99 again has first and second lip regions 105, 107. The lip region 105 terminates in a flared collar region 103 comparable to the region 63 of the seal illustrated in FIG. 3. In this case, however, the collar region 103 is a planar member of generally uniform thickness. There is no annular recess or groove similar to the recess of the seal structure 53 shown in FIG. 3.

As shown in FIG. 5, the collar region 103 forms a circumferential shelf region 109 upon which the filter element end 110 is received. The planar collar region 103 of the seal structure thus forms a seal with the selected end 110 of the filter element with the filter element resting upon the upper planar surface thereof. The opposite side of the collar region forms a compression type seal with the upper extent 32 of the riser 30. In this case, the upper extent 32 of the riser 30 forms a planar upper surface for supporting the seal structure.

FIG. 7 shows another version of the vertical riser 30 and partition 85 in greater detail. In addition to the upwardly extending cylindrical sidewalls, the riser 30 has a flared upper extent 69 which terminates in an upwardly extending thimble region 71. The thimble region 71 forms a relatively narrow “edge” at an outer extent of the riser. The lower surface 104 of the flared collar region of the seal structure 99 forms a compression seal with the edge of the circumferential thimble region 71 of the riser 30 as the edge bites into the collar region 103 of the seal structure in use.

As best seen FIG. 7A, the sealing effect achieved between the thimble region 71 of the riser 30 and the flared collar region 103 of the seal structure can be roughly analogized to a flat gasket type sealing arrangement. In other words, the knife edge of the thimble region 71 seals the circumferential region of contact with the exposed side of the collar region 103. As will be appreciated from FIG. 7A, the filter element body also expands outwardly (shown in exaggerated fashion) to form a seal with the riser interior sidewalls 106 when subjected to a pressure differential between an upstream portion of the process and a downstream portion of the process being filtered. The direction flow of the gas being filtered is from the outside to the interior 93 of the filter and downwardly out the end opening 110, as illustrated in FIG. 7A. This creates a high pressure region above the partition and within the filter element and a relatively lower pressure region below the partition in the region of the seal structure. The seal which is formed between the conically shaped sidewalls of the seal structure 99 and the riser interior 106 is thus an “annular” seal along the length of the conically shaped sidewalls which is energized by the differential pressure created between existing upstream and downstream process conditions. This sealing effect can be roughly analogized to an o-ring sliding seal effect.

FIG. 8 is a schematic view similar to FIG. 7 but illustrates the cylindrical sidewalls of the riser which extend vertically upward from the planar partition 29 in the gas filtration vessel of FIG. 1. The cylindrical sidewalls 111 of the riser 31 extend upwardly within the interior of the filter element interior 43 and also within an interior region of the seal structure where it contacts and seals against the seal structure in use. The seal structure 53 extends for a predetermined length “l” between the opposing outer lips 59, 61 thereof, whereby the length of the seal structure occupies a given distance within the interior of the filter element 27. As a result, liquid flow through the element from the inside to the outside thereof, (illustrated by arrows in FIG. 8) is directed higher up the interior of the filter element 27 than would occur without the sealing structure 53 being present within the interior of the filter element. The seal structure 53 illustrated in FIG. 8 thus has multiple areas where the seal will contact the filter element support (riser) to maintain a positive sealing surface. These multiple contact areas provide advantages from standard sealing arrangement that feature only gasket or o-ring type seal structures.

An invention has been provided with several advantages. The seal structure of the invention is simple in design and economical to manufacture. The seal structure of the invention has multiple areas where the seal will contact the filter element support structure to maintain positive sealing surfaces. The result is more effective sealing area than was available from the prior art arrangements featuring gasket and o-ring type seals. The seal structure of the invention can be used in a wide variety of process applications involving both liquid and gas filtration. The improved seal structure provides an annular seal which utilizes the differential pressure between the upstream and downstream sides of the filter element to aid in effecting an improved seal.

While the invention is shown in only one of its forms, it is not just limited but is susceptible to various changes and modifications without departing from the spirit thereof.

We claim:

1. A seal structure for a tubular filter element used to filter a fluid stream in an industrial process where the fluid stream passes through a filter vessel having rigid risers for mounting the filter elements, each of the filter elements comprising a tubular body with generally cylindrical sidewalls formed of a porous material, an interior, a first end opening and an oppositely arranged second end opening, the improved seal structure of the invention comprising:
a resilient body having conically shaped sidewalls which are tapered with respect to a central axis of the resilient body and which extend between a first lip region and a second lip region of the body;
wherein a selected one of the first and second lip regions of the resilient body is adapted to seal on a selected end opening of the filter element and wherein the conically shaped sidewalls of the filter element form a dynamic seal with the riser element of the filter vessel on which the filter element is mounted and with the filter element body when subjected to a pressure differential between an upstream portion of the process and a downstream portion of the process being filtered.

2. The seal structure of claim 1, wherein a selected one of the first and second lip regions of the body terminates in a flared collar region also formed of a resilient material and with opposing exposed sides, whereby one of the opposing exposed sides of the collar region seals against an end opening of the filter element and the other opposing side seals against the vessel riser.

3. The seal structure of claim 2, wherein the vessel riser has a circumferential thimble region which forms a relatively narrow edge at an outer extent thereof, the selected opposing exposed side of the flared collar region of the seal structure forming a compression seal with the edge of the circumferential thimble region of the riser as the edge bites into the collar region of the seal structure in use.

4. The seal structure of claim 3, wherein the seal formed between the thimble region of the riser and the flared collar region of the seal structure is in the nature of an o-ring compressive seal, while the seal formed between the conically shaped sidewalls of the seal structure and the riser interior is an annular seal along the length of the conically shaped sidewalls which is energized by the differential pressure created between existing upstream and downstream process conditions.

5. The seal structure of claim 1, wherein the conically shaped tapered sidewalls of the seal structure form a relatively larger outer diameter flared top for the seal structure which extends downwardly toward a relatively narrower bottom region of the seal structure, and wherein the seal structure is received within the interior of the riser with the flared top thereof forming a seal with a selected end opening of the filter element.

6. The seal structure of claim 2, wherein the vessel riser extends upwardly within the interior of the filter element interior and within an interior region of the seal structure where it contacts and seals against the seal structure in use.

7. The seal structure of claim 6, wherein the seal structure extends for a predetermined length between the opposing outer lips thereof, whereby the length of the seal structure occupies a given distance within the interior of the filter element and as a result liquid flow through the element from the inside to the outside thereof is directed higher up the interior of the filter element than would occur without the sealing element being present within the interior of the filter element.

8. An apparatus for filtering a fluid stream, the apparatus comprising:
a closed vessel having a length and an initially open interior;
a partition disposed within the vessel interior, the partition having a planar inner and planar outer side, respectively, dividing the vessel interior into a first chamber and a second chamber;
at least one opening in the partition;
a rigid riser mounted on the partition opening for receiving a filter element thereon;
an inlet port in fluid communication with the first chamber;
an outlet port in fluid communication with the second chamber;
at least one tubular filter element mounted on the riser within the vessel interior, the filter element comprising a tubular body with generally cylindrical sidewalls formed of a porous material, an interior, a first end opening and an oppositely arranged second end opening;
wherein a seal structure is used to mount the filter element on the riser element, the seal structure comprising a resilient body having conically shaped sidewalls which are tapered with respect to a central axis of the resilient body and which extend between a first lip region and a second lip region of the body;
wherein a selected one of the first and second lip regions of the resilient body is adapted to seal on a selected end opening of the filter element and wherein the conically shaped sidewalls of the filter element form a dynamic seal with the riser element of the filter vessel on which the filter element is mounted and with the filter element body when subjected to a pressure differential between an upstream portion of the process and a downstream portion of the process being filtered.

9. The apparatus of claim 8, wherein a selected one of the first and second lip regions of the body terminates in a flared collar region also formed of a resilient material and with opposing exposed sides, whereby one of the opposing exposed sides of the collar region seals against an end opening of the filter element and the other opposing side seals against the vessel riser.

10. The apparatus of claim 9, wherein the vessel riser has a circumferential thimble region which forms a relatively narrow edge at an outer extent thereof, the selected opposing exposed side of the flared collar region of the seal structure forming a compression seal with the edge of the circumferential thimble region of the riser as the edge bites into the collar region of the seal structure in use.

11. The apparatus of claim 10, wherein the seal formed between the thimble region of the riser and the flared collar region of the seal structure is in the nature of an o-ring compressive seal, while the seal formed between the conically shaped sidewalls of the seal structure and the riser interior is an annular seal along the length of the conically shaped sidewalls which is energized by the differential pressure created between existing upstream and downstream process conditions.

12. The apparatus of claim 8, wherein the conically shaped tapered sidewalls of the seal structure form a relatively larger outer diameter flared top for the seal structure which extends downwardly toward a relatively narrower bottom region of the seal structure, and wherein the seal structure is received within the interior of the riser with the flared top thereof forming a seal with a selected end opening of the filter element.

13. The apparatus of claim 9, wherein the vessel riser extends upwardly within the interior of the filter element interior and within an interior region of the seal structure where it contacts and seals against the seal structure in use.

14. The apparatus of claim 13, wherein the seal structure extends for a predetermined length between the opposing outer lips thereof, whereby the length of the seal structure occupies a given distance within the interior of the filter element and as a result liquid flow through the element from the inside to the outside thereof is directed higher up the interior of the filter element than would occur without the sealing element being present within the interior of the filter element.

15. The apparatus of claim 8, wherein the fluid stream is a gas stream and wherein the filter elements each have a filter wall and a hollow core and wherein the inlet port, the vessel interior, the tubular filter elements, and the outlet port together define a flow passage within the apparatus, whereby the gas stream flows through the inlet port into the first chamber, through hollow core of the filter elements and out the sidewalls thereof, and then from the second chamber out the outlet port, thereby separating impurities out of the gas stream, and whereby the gas stream then flows out of the second chamber through the outlet port.

16. The apparatus of claim 8, wherein the fluid stream is a liquid stream and wherein the filter elements each have a filter wall and a hollow core and wherein the inlet port, the vessel interior, the tubular filter elements, and the outlet port together define a flow passage within the apparatus, whereby the liquid stream flows into the first chamber through the inlet port, through the sidewalls of the filter elements into the interior thereof, and out the filter elements and second chamber to the outlet port.
